(19) United States
(12) Patent Application Publication
(10) Pub. No.: US 2008/0071645 A1
(43) Pub. Date: Mar. 20, 2008

(54) METHOD OF PRESENTING, DEMONSTRATING AND SELLING VEHICLE PRODUCTS AND SERVICES

(76) Inventor: Peter Latsoudis, Chicago, IL (US)

Correspondence Address: MICHAEL RIES, 318 PARKER PLACE, OSWEGO, IL, 60543, US

(21) Appl. No.: 11/856,032

(22) Filed: Sep. 15, 2007

Related U.S. Application Data
(60) Provisional application No. 60/825,825, filed on Sep. 15, 2006.

(51) Int. Cl. G06Q 30/00

(52) U.S. Cl. 705/27

(57) ABSTRACT

The automotive customer can engage in an online dynamic video presentation and demonstration of automobiles by calling by phone a pre-designated telephone number, then connecting by computer to an IP Network camera using a cellular broadband service. Speaking to the automotive representative by telephone and seeing remotely online dynamic video during product presentation and demonstration. This method establishes communication between an automotive customer and automotive sales representative for the purposes relating to and selling of automobiles remotely.

This application claims priority to U.S. Provisional Application 60825825 filed Sep. 15, 2006, the entire disclosure of which is incorporated by reference.

### FIELD OF THE INVENTION

The present invention relates to a method of presenting, demonstrating and selling vehicles such as automobiles, automotive producers and services using mobile online dynamic video transmission, mobile cellular internet broadband service and telephony.

### BACKGROUND OF THE INVENTION

This method of invention is related to the process of presenting, demonstrating, appraising and selling automobiles. Online visual interaction and audio telephony between an automotive purchaser and automotive seller by use of this method occurs by using this process and application of dynamic video, mobile cellular broadband internet service and telephony.

This process Improves the current method of online automobile product viewing being used by Automobile dealers of sending or receiving by electronic mail the viewer a static image of the vehicle being inquired about bye-mail or printed advertisement.

The mobility of this method allows the automotive dealer to conduct presentations, demonstrations and appraisals of automobile, automotive products and services from locations a cellular phone and wireless broadband connection can be established.

It enables an automobile dealers Inventory of multiple automobiles to remain at their current locations and be viewed remotely. Only the automotive presenter equipped with a cellular telephone and the cellular mobile video system needs be transported.

Videoconferencing as an application is available enabling the parties to see video and hear audio. Video and voice data frequently are used together in present videoconferencing systems and require a videoconferencing service and compatible computers and operating systems. Only when both parties have compliant software, hardware and or service can they communicate together over a network through the internet and view a dynamic video and receive sound for presentations.

Frequently this requires downloading and installing the software by both parties to their relative computer systems prior to engaging in an online presentation.

By use of the current method it is required that the automobile viewing customer and automotive product presenting seller in using this prior method of application to inefficiently spend valuable interaction time for other than the purpose of an online product presentation and demonstration when an automobile inquiry has been requested or reply sent.

The illustrative method of establishing an online and audio telephony of automobile product presentations and demonstrations are disclosed herein. An automotive customer as the viewer receives from the automotive representative acting as the presenter the weblink and pre-designated telephone phone number to call by email phone call, displayed advertisement or any other means of communication.

The automotive customer using an internet connected computer, video display and internet browser clicks or enters the weblink to begin receiving a transmission from the IP Network web capable camera transmitting video data through a data capable cellular modem using mobile cellular wireless broadband service.

In conjunction the automotive customer calls the pre-designated telephone phone number and speaking to the automotive presenter by telephone together a video and audio interaction of pertaining information occurs between both parties for the purposes of presentation, demonstration leading to the sales, lease, rental or appraisal of automobiles, automotive products and or services.

This process improves the current method of online automobile product viewing being used by Automobile dealers of sending or receiving by electronic mail the viewer a static image of the vehicle being inquired about bye-mail or printed advertisement.

The mobility of this method allows the automotive dealer to conduct presentations, demonstrations and appraisals of automobile, automotive products and services from locations a cellular phone and cellular wireless broadband connection can be established.

It enables an automobile dealers inventory of multiple automobiles to remain at their current locations and be viewed remotely. Only the automotive presenter equipped with a cellular telephone and the cellular mobile video system needs be transported.

Videoconferencing as an application is available enabling the parties to see video and hear audio. Video and voice data frequently are used together in present videoconferencing systems and require a videoconferencing service and compatible computers and operating systems. Only when both parties have compliant software, hardware and or service can they communicate together over a network through the internet and view a dynamic video and receive sound for presentations.

Frequently, this requires downloading and installing the software by both parties to their relative computer systems prior to engaging in an online presentation.

By use of the current method it is required that the automobile viewing customer and automotive product presenting seller in using this prior method of application to inefficiently spend valuable interaction time for other than the purpose of an online product presentation and demonstration when an automobile inquiry has been requested or reply sent.

### BRIEF DESCRIPTION OF THE DRAWINGS

FIG. 1 is a schematic of the present invention;

FIG. 2A is a flow diagram of the present invention; and

FIG. 2B is a continuation of the flow diagram from FIG. 2A.

### DETAILED DESCRIPTION OF THE PREFERRED EMBODIMENTS

The automotive representative acting as an online presenter sends by means of a computing device as a computer, World Wide Web capable cellular phone or by telephony an e-mail, voice call, displayed on the Automobile dealers website or printed advertisement the connecting weblink where the IP Network Web capable camera is located and the pre-designated telephone number to the presenters portable telephone.

The automotive customer as the viewer can receive by using a computer, World Wide Web capable cellular phone the e-mail, audio by telephone, viewing printed or online advertisement the connecting weblink where the IP Network Web capable cameras Internet protocol address is located and the pre-designated telephone number to call.

The viewer having already previously established an Internet connection and using a computer or World Wide Web capable cellular phone and relative video display enters in the weblink address into the Internet browsers address form location to establish a connection to the IP Network Web capable camera Internet protocol address. The weblink can also be clicked by a computer mouse, touch screen panel, voice command and an embedded as an auto forwarded computing code placed in the e-mail message.

The automotive customer calls by means of telephony the pre-designated telephone number that connects to the presenters mobile or wireless land satellite, voice over internet protocol telephone. In speaking to the presenter the viewer will be enabled to listen to pertaining information about the automotive product during presentation and demonstration, This enables the customer to request and query about other related information about an automobile or automotive product or services.

The dynamic video of the automobile is transmitted and work together by way of a IP Network Web capable camera such as available through IQ invision, Mobotix, Arecont, Luminera, Sony, Panasonic and connected by a data cable WiFI Bluetooth and or radio frequency to a digital data capable cellular broadband modem such as Airlinks Raven, Sierra Wireless modem Dlink Junxion and Kyocera and connected through mobile cellular broadband service providers such as Verizon Sprint, Cingular and T Mobile.

The IP Network camera, digital data capable cellular broadband modem having mobile broadband service are attached to a mobile stand built using casters, pole and support brackets available by companies as Ergotron and connected to an attached portable battery power source available through companies as Xantrex, Circuit City and Geek Squad allowing the automobile presenter to physically move the camera in towards, away from and around the automotive product showing the features, condition, perspective dimensions and accessories.

The internet connection for the IP Network camera can be constructed by using a cellular modem wired modem, radio frequency modem, satellite modem and or microwave modem.

The sending of the dynamic video is accomplished by the IP Network Web capable video camera from its assigned Internet protocol address by forwarding the requested video data to the digital data capable cellular modem by the use of port forwarding.

The cellular modem from its assigned Internet protocol address sends the video data transmission signal using a cellular broadband Internet service from the current cell location to a cellular tower base station that handles all incoming and outgoing data traffic and is then sent to a modem pool at a switching center. The data signal proceeds to the public switched telephone network connected to a fixed end modem and then to a web server. The web server is connected to the Internet and transmits using the World Wide Web to the computing device requesting the video data.

The automotive viewing customer using a computer with display, Internet connection, and Internet browser enters, clicks or allows auto forwarding to of the weblink address. When this process has been completed, dynamic video of the automobile can be transmitted and seen by the viewing customer.

The viewer and presenter calls and receive through telephony which can be by use of a land line, cellular service, voice over internet protocol or satellite phone and using the pre-designated telephone number are enabled to hear or query and communicate about information relative to the automotive product and services during presentation and demonstration.

The automotive presenter and automotive viewing customer are allowed by this process to continue this method of invention for purposes of viewing other automotive products located remotely than may have been originally been intended at the start of the method of demonstration and presentation inquired, sent, or advertised.

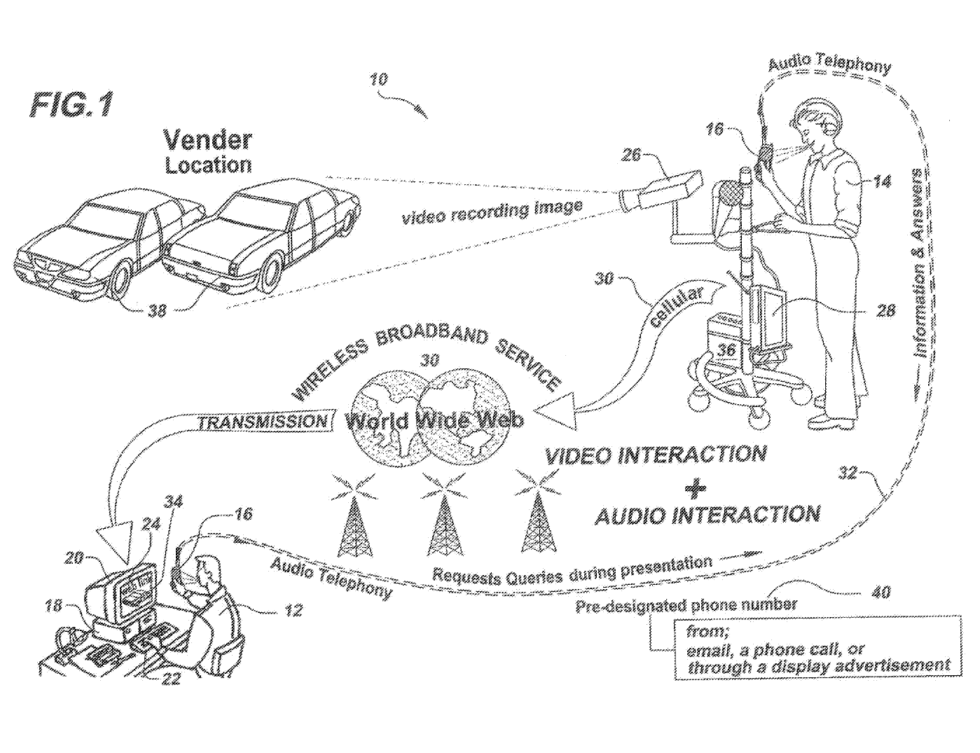

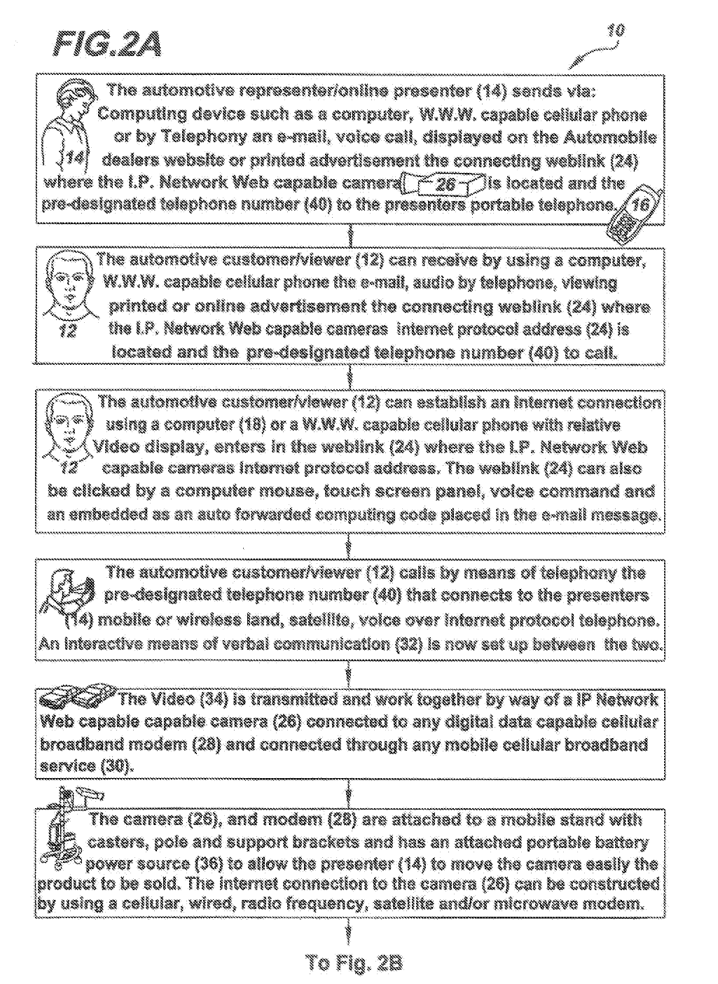

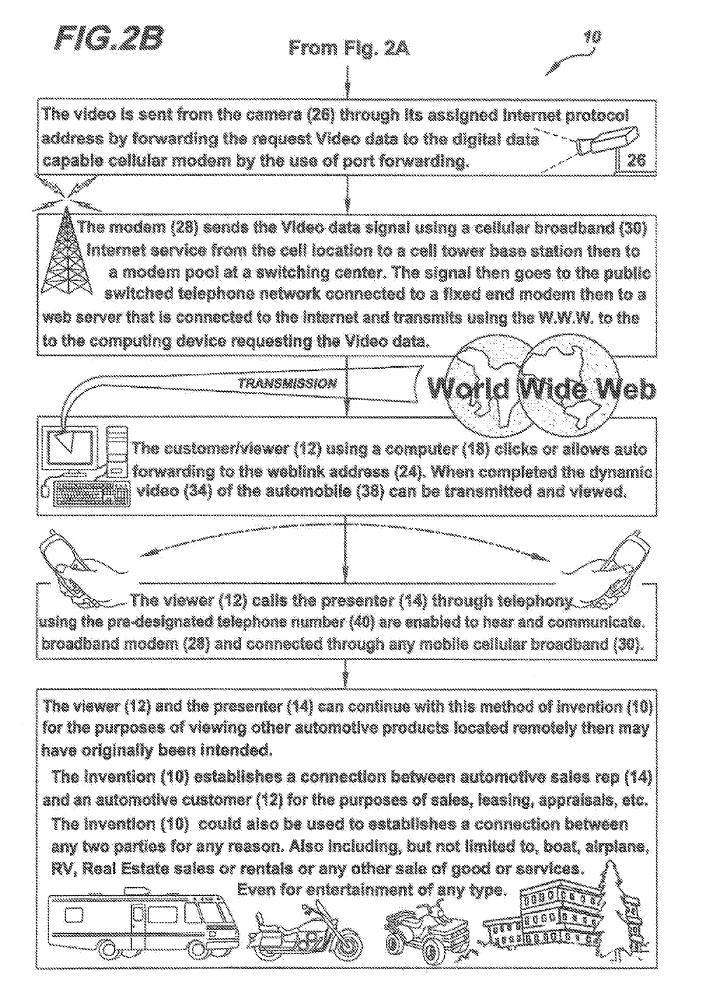

FIG. 1, FIG. 2A and FIG. 2B as in one embodiment of the present show a flow diagram 10 explaining the present invention and how the present invention works. Shown is the automotive customer/viewer 12 and the automotive sales representative/presenter 14. A cell phone 16 and a previously established internet connected computer or World Wide Web capable cellular phone with relative video display 18. A video component display 20, an internet browser 22 and a weblink 24 is shown. An I.P network web capable camera 26 such as ones available through IQ invision, Mobotix, Arecont, Luminera, Sony and Panasonic is shown. A data capable cellular broadband modem 28 is shown such as Airlinks Raven, sierra Wireless modem, Dlink that is connected to the camera 26 by a data cable, WiFi Bluetooth and/or radio frequency. Shown is a mobile cellular wireless broadband service provider 30 such as Verizon, Sprint, Cingular and T Mobile. An audio interaction of information 32 is shown. A dynamic video data display 43 is shown of the presentation and demonstration in real time. An attached portable battery power source 36 is shown. An automobile, automotive product or service 38 is shown. A pre-designated phone number 40 is shown.

1. A method of presenting comprising:
sending a sales presentation of a vehicle by an online presenter, a video feed being recoded and sent from a mobile stand that the online presenter moves around the vehicle while speaking into an audio feed;
receiving the sales presentation by a customer, the video feed is received over the Internet and the audio feed has a pre-designated phone that the customer will call.

2. A method of interaction video and audio comprising:
sending a sales presentation of a vehicle by an online presenter, a video feed being recorded and sent from a mobile stand that the online presenter moves around the vehicle while speaking into an audio feed, the video feed is created by a wireless camera mounted to the mobile stand, the audio feed is created by connecting the online presenter and customer's cell phones by the customer calling a pre-designated phone number that the customer received from the online presenter from a selected one of an email, phone call or displayed in an advertisement; and
receiving the sales presentation by a customer, the video feed is received over the Internet and the audio feed allows the customer to make requests to the online presenter and allows the online presenter to answer the requests and provide vehicle information by a selected one of the audio feed, video feed or both.
